(19) United States
(12) Patent Application Publication
(10) Pub. No.: US 2007/0223402 A1
(43) Pub. Date: Sep. 27, 2007

(54) Device, system and method of extended-range wireless communication

(76) Inventor: Shai Waxman, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/384,362

(22) Filed: Mar. 21, 2006

(51) Int. Cl. H04B 7/00

(52) U.S. Cl. 370/277

(57) ABSTRACT

Some embodiments of the invention provide devices, systems and methods of extended-range wireless communication. For example, a method in accordance with an embodiment of the invention includes receiving a probe request including an indication of a requested transmission scheme, and transmitting a data packet using the requested transmission scheme.

### BACKGROUND OF THE INVENTION

In the field of wireless communications, Space-Time Block Codes (STBC) communication technique or Beam Forming (BF) communication technique may be utilized, for example, to extend connectivity range between a wireless Access Point (AP) and a wireless communication station. For example, the wireless AP may transmit a packet having a header portion and a data portion. The header may be transmitted, for example, using non-STBC communication, whereas the data portion may be transmitted using STBC communication.

Unfortunately, since the packet header is transmitted using non-STBC communication, a remote wireless communication station may not be able to receive the packet, and an extended connectivity range may not be achieved.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system able to utilize extended-range wireless communication in accordance with an embodiment of the invention;

FIG. 2 is a schematic timing diagram of wireless communication signals in accordance with an embodiment of the invention; and

FIG. 3 is a schematic flow-chart of a method of extended-range wireless communication in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a tablet computer, a server computer, a Personal Digital Assistant (PDA) device, a network, a wireless network, a Local Area Network (LAN), a Wireless LAN (WLAN), devices and/or networks operating in accordance with existing IEEE 802.11, 802.11a, 802.11b, 802.11e, 802.11g, 802.11h, 802.11i, 802.11n, 802.16 standards and/or future versions of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

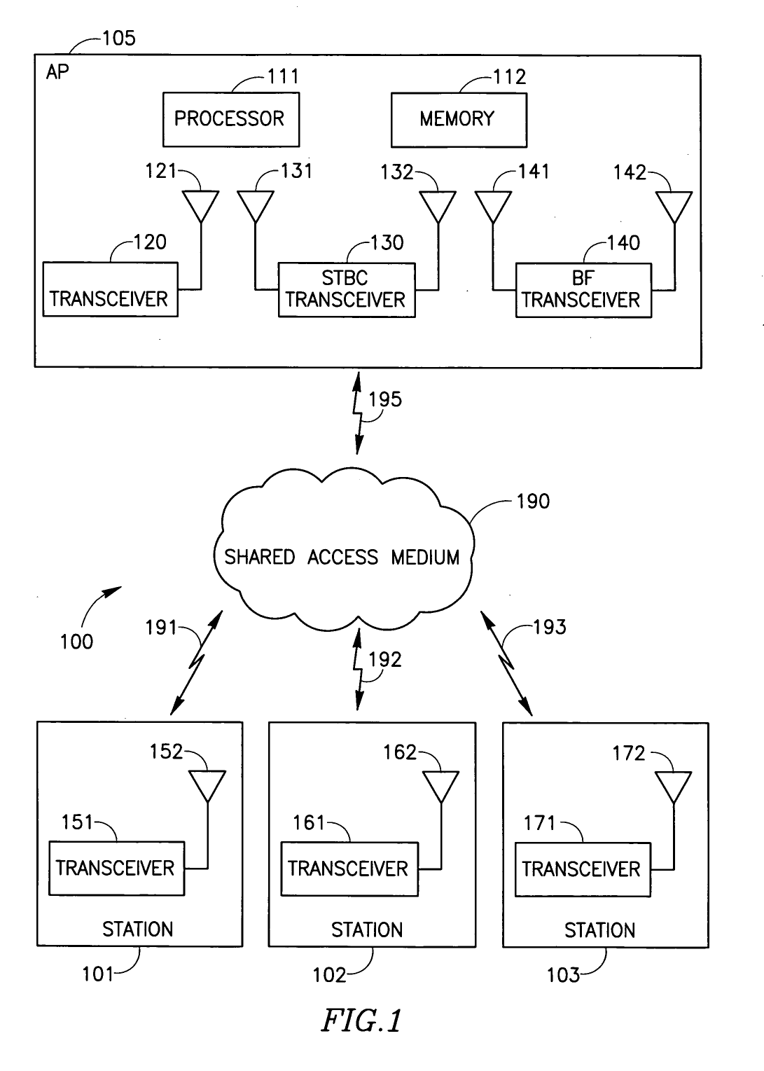

FIG. 1 schematically illustrates a block diagram of a wireless communication system 100 able to utilize extended-range wireless communication in accordance with an embodiment of the invention. System 100 may include one or more wireless communication stations, for example, stations 101, 102 and 103. System 100 may further include one or more wireless devices, for example, a wireless Access Point (AP) 105. Station 101, station 102, station 103, and AP 105 may communicate using a shared access medium 190, for example, through wireless communication links 191, 192, 193, and 195, respectively.

In some embodiments, system 100 may be or may include one or more wireless communication networks, for example, an a-synchronic wireless network or an asynchronous wireless network, and/or a synchronic wireless network. For example, in some embodiments, one or more components of system 100 may be able to operate in accordance with a first wireless communication standard, e.g., IEEE 802.11 standard, which may be a-synchronic, asynchronous, burstable, or the like; whereas one or more other components of system 100 may be able to operate in accordance with a second wireless communication standard, e.g., IEEE 802.16 standard, which may be synchronic, non-burstable, or the like. In some embodiments, for example, one or more components of system 100 may be hybrid wireless devices, e.g., having multiple wireless transceivers and/or able to operate in accordance with multiple wireless communication standards or protocols.

Station 101 may include, for example, a wireless RF transceiver 151 able to transmit and receive wireless communication signals, e.g., utilizing an antenna 152. For example, transceiver 151 may be able to operate in accordance with IEEE 802.11 standard, e.g., IEEE 802.11n standard. Station 101 may include other suitable hardware components and/or software components.

Station 102 may include, for example, a wireless RF transceiver 161 able to transmit and receive wireless communication signals, e.g., utilizing an antenna 162. For example, transceiver 161 may be able to operate in accordance with IEEE 802.11 standard, e.g., IEEE 802.11n standard. Transceiver 161 may be able to utilize a first Transmission Antenna Diversity Scheme (TADS), for example, Space-Time Block Codes (STBC) communication scheme, e.g., using a STBC equalizer which may be included in transceiver 161 or may be operatively associated with transceiver 161. Station 102 may include other suitable hardware components and/or software components.

Station 103 may include, for example, a wireless RF transceiver 171 able to transmit and receive wireless communication signals, e.g., utilizing an antenna 172. For example, transceiver 171 may be able to operate in accordance with IEEE 802.11 standard, e.g., IEEE 802.11n standard. Transceiver 171 may be able to utilize a second TADS, for example, Beam Forming (BF) communication scheme, e.g., using signal targeting or signal focusing techniques. Station 103 may include other suitable hardware components and/or software components.

AP 105 may include, for example, a processor 111, a memory unit 112, and one or more wireless transceivers, e.g., a transceiver 120, a STBC transceiver 130, and a BF transceiver 140. In some embodiments, transceiver 120, STBC 130 and/or BF transceiver 140 may be implemented using a single or multiple transceiver(s) or unit(s). AP 105 may include other suitable hardware components and/or software components.

Processor 111 may include, for example, a Central Processing Unit (CPU), a Digital Signal Processor (DSP), a microprocessor, a controller, a chip, a microchip, one or more circuits, an Integrated Circuit (IC), or any other suitable multi-purpose or specific processor or controller. Processor 111 may, for example, process signals and/or data transmitted and/or received by AP 105.

Memory unit 112 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Memory unit 112 may, for example, store data transmitted and/or received by AP 105.

Transceiver 120 may include, may include, for example, a wireless RF transceiver able to transmit and receive wireless communication signals, e.g., utilizing an antenna 121. For example, transceiver 120 may be able to operate in accordance with IEEE 802.11 standard, e.g., IEEE 802.11n standard. For example, transceiver 120 of AP 105 may communicate with transceiver 151 of station 101.

STBC transceiver 130 may include, for example, a wireless RF transceiver able to transmit and receive wireless communication signals utilizing STBC. For example, STBC transceiver 130 may utilize multiple antennas, e.g., a first antenna 131 and a second antenna 132, to transmit a symbol at a first time slot and at a second, different, time slot, respectively. For example, STBC transceiver 130 of AP 105 may communicate with transceiver 161 of station 102. In some embodiments, STBC transceiver 130 may utilize open-loop communication and/or broadcasting, e.g., without a need to receive feedback from transceiver 151 for subsequent transmissions by STBC transceiver 130.

For example, STBC transceiver 130 may use a STBC scheme to transmit multiple copies of a data stream across multiple antennas, utilizing the various received versions of the data in order to improve the reliability of data transfer. The transmitted data may traverse an environment which may cause scattering, reflection, corruption, or the like, such that some of the received copies of the data may be better than others. The redundancy may increase the ability of the remote receiver to use one or more of the received copies of the data to correctly decode the received signal. In some embodiments, the STBC scheme may combine substantially all the copies of the received signal in order to extract as much information from them as possible.

The STBC scheme may include transmission of multiple redundant copies of data to compensate for fading and thermal noise. The data stream to be transmitted may be encoded in blocks, which may be distributed among spaced antennas and across time. The receiving station may have, but is not required to have, multiple receive antennas, and may utilize diversity reception. Characteristics of the STBC scheme may be represented using a matrix, for example, such that a row may represent a time slot, and a column may represent transmissions of an antenna over time.

BF transceiver 140 may include, for example, a wireless RF transceiver able to transmit and receive wireless communication signals utilizing BF. For example, BF transceiver 140 may utilize multiple antennas, e.g., a first antenna 141 and a second antenna 142, to transmit a symbol at a certain time slot. For example, BF transceiver 140 of AP 105 may communicate with transceiver 171 of station 103. In some embodiments, BF transceiver 140 may utilize closed-loop communication, e.g., utilizing an implicit feedback received from transceiver 171 (e.g., acknowledgement packets) and/or explicit feedback received from transceiver 171 (e.g., explicit feedback packets).

In some embodiments, for example, BF transceiver 140 may focus a narrow beam targeted towards a single receiving station, e.g., utilizing a “smart” antenna array. For example, a linearly arranged and equally spaced array of antennas may be used by BF transceiver 140 to transmit data. In order to form a “beam”, the information signal may be multiplied by a set of complex weights, wherein the number of weights may equal to the number of antennas used, and then may be transmitted by the antenna array. The signals emitted from different antennas in the array may differ in phase, e.g., based on the distance between antenna elements; and may further differ in amplitude, e.g., based on the various weights associated with various antennas. The direction of the beam may be set or modified, for example, by setting or modifying the values of the complex weights used in for multiplying, and/or by steering the direction of the antenna array. BF transmission may take advantage of interference to change the directionality of the antenna array; for example, when transmitting, the BF transceiver may controls the amplitude and phase of the signal at each antenna, in order to create a pattern of constructive and destructive interference in the wavefront.

Various methods may be used for setting or modifying the direction of the beam, for example, a switched BF scheme, an adaptive BF scheme, a BF scheme including Direction Of Arrival (DOA) estimation, a BF scheme utilizing an Estimation of Signal Parameters via Rotational Invariance Techniques (ESPRIT) algorithm, a BF scheme utilizing a Multiple Signal Classification (MUSIC) algorithm, a BF scheme utilizing a Min-Norm algorithm, a BF scheme utilizing a root-MUSIC algorithm, a BF scheme utilizing a sequential MUSIC algorithm, a BF scheme utilizing a Capon beamformer, a BF scheme utilizing a Rank Reduction Estimator (RARE) algorithm, or the like.

In some embodiments, for example, a switched BF scheme may be used. For example, the complex weights used may be selected from a “library” of weights that form beams in specific, predetermined directions. Optionally, a hand-off between beams may be used as a receiving station may move tangentially to the antenna array.

In other embodiments, for example, an adaptive BF scheme may be used. For example, the weights may be computed and adaptively updated in substantially real time. In some embodiments, the adaptive process may allow narrower beams and reduced output in other directions, and may improve the Signal to Interference-plus-Noise Ratio (SINR). In some embodiments, an adaptive BF scheme may be used, for example, with a Rake receiver architecture, e.g., as a Rake beam-former structure able to provide processing gains in both the temporal and spatial domains. In some embodiments, for example, an adaptive BF scheme may utilize adaptive signal processing algorithms, e.g., Least Mean Squares (LMS), Normalized LMS (NLMS), or Recursive Least Squares (RLS). In some embodiments, other BF methods may be used, for example, a BF scheme utilizing Singular Value Decomposition (SVD) per subcarrier, e.g., utilizing multiple directional beams.

AP 105 may periodically or repeatedly transmit a beacon signal, e.g., using transceiver 120, optionally in accordance with an IEEE 802.11 standard. In some embodiments, stations 101-103 may be located remotely from AP 105, and may not receive the beacon signal, or may not properly receive the beacon signal, or may have a low or relatively low reliability of reception. For example, station 102 and/or station 103 may determine that they may not reliably receive signals from AP 105, e.g., based on a low Signal to Noise Ratio (SNR), based on a marginal detection, based on a reliability parameter, based on poor reception of the beacon signal, based on no reception of the beacon signal, or the like.

Stations 101, 102 and/or 103 may perform an active scanning, e.g., may transmit a probe request. The probe request may include a Requested Transmission Scheme (RTS) field, which may include a value of a RTS parameter or other indication. The value of the RTS parameter may indicate to AP 105 a transmission scheme (e.g., a TADS) requested by stations 101, 102 and/or 103. In some embodiments, for example, the AP 105 may determine, e.g., based on a received probe request and/or other information, that AP 105 is requested or required to transmit data to a certain station using a certain extended-range transmission scheme, for example, TADS, STBC, BF, or the like; and may transmit data (e.g., subsequent data packets, including header portions and data portions) to that station using the requested or required scheme.

In some embodiments, for example, station 101 may transmit a probe request including a value of a RTS parameter, e.g., a value of “0” indicating that station 101 requests that subsequent transmissions by AP 105 to station 101 utilize a single antenna of AP 105, and/or utilize Cyclic Delay Diversity (CDD).

In some embodiments, for example, station 102 may transmit a probe request including a value of a RTS parameter, e.g., a value of “1” indicating that station 102 requests that subsequent transmissions by AP 105 to station 102 utilize STBC communication and/or multiple antennas of AP 105. Optionally, the value of the RTS parameter may indicate, in addition to the request of station 102 that AP 105 transmits data utilizing STBC communication, a number of antennas that AP 105 is requested to utilize for STBC transmissions to station 102.

In some embodiments, for example, station 103 may transmit a probe request including a value of a RTS parameter, e.g., a value of “2”, indicating that station 103 requests that subsequent transmissions by AP 105 to station 103 utilize BF communication and/or multiple antennas of AP 105. Optionally, the value of the RTS parameter may indicated, in addition to the request of station 103 that AP 105 transmits data utilizing BF communication, a number of antennas that AP 105 is requested to utilize for BF transmissions to station 103.

In some embodiments, for example, the value of the RTS parameter may indicate whether the AP 105 is requested to transmit using a single antenna, to transmit using STBC, or to transmit using BF, in subsequent transmissions to the requesting station. Additionally or alternatively, the value of the RTS parameter may indicate a number of antennas (e.g., one, two, four, or the like) that the AP 105 is requested to utilize for subsequent transmissions to the requesting station.

In some embodiments, the probe request may be used for active scanning by a station, for example, to indicate (e.g., using a value of a parameter in a field of the probe request) a requested transmission scheme, a requested number of transmission antennas to be used, and/or other attributes of a requested transmission scheme.

In response to a probe request indicating that AP 105 is requested to transmit using STBC, optionally, the AP 105 may repeatedly or periodically transmit beacon signals using STBC, for example, in addition to or instead of transmitting non-STBC beacon signals. For example, the probe request transmitted by station 102 may indicate to AP 105 that station 102 requests to communicate using STBC, and AP 105 may thus periodically or repeatedly transmit STBC beacon signals. In some embodiments, for example, the probe request(s) may trigger the AP 105 to periodically transmit STBC beacon signals, e.g., if such transmission was previously disabled, e.g., if no other station was already associated with AP 105 using STBC.

Additionally or alternatively, in response to the probe request, AP 105 may transmit a probe response if AP 105 is able to transmit using the requested transmission scheme. The probe response may, for example, include an indication acknowledging or approving the request embedded in the probe request. The probe response may be transmitted by AP 105 using the transmission scheme requested in the probe request. For example, in response to the probe request transmitted by station 102, STBC transceiver 130 of AP 105 may transmit a probe response using STBC; and in response to the probe request transmitted by station 103, BF transceiver 140 of AP 105 may transmit a probe response using BF. The probe response may be transmitted using substantially the lowest transmission rate (“basic rate”) of the wireless communication standard in use, e.g., a basic rate of approximately 6 or 6.25 or 6.5 Megabit per second when the IEEE 802.11n standard is used.

In some embodiments, optionally, the probe response may be transmitted by AP 105 utilizing a “back-off” mechanism, for example, a random or pseudo-random delay period, e.g., to allow other access points to contend for communication with the station that transmitted the probe request.

Subsequent to transmission of the probe response(s) by AP 105, association and data transfer between AP 105 and a station may be performed using the transmission scheme requested by that station. For example, association and protected data transfer between AP 105 and station 102 may be performed using STBC; whereas association and protected data transfer between AP 105 and station 103 may be performed using BF. In some embodiments, the association and data transfer may be in accordance with a wireless communication standard, for example, the IEEE 802.11n standard, and may optionally utilize substantially the lowest transmission rate (“basic rate”) of the wireless communication standard in use, e.g., a basic rate of approximately 6 or 6.25 or 6.5 Megabit per second when the IEEE 802.11n standard is used.

In some embodiments, for example, station 102 may transmit a probe request indicating that AP 105 is requested to transmit data to station 102 using STBC. Based on the probe request, AP 105 may transmit data to station 102 using STBC, for example, using protected transmission(s), e.g., ensuring that station 102 receives the protected transmission(s) intended to be received by station 102, whereas other stations 101 and 103 do not receive the protected transmission(s) intended by AP 105 to be received by station 102.

In some embodiments, for example, AP 105 may register that subsequent transmissions to a certain station may be performed utilizing a certain, respective, requested transmission scheme. For example, AP 105 may register that subsequent transmissions to station 102 may be performed using STBC communication, whereas subsequent transmissions to station 103 may be performed using BF communication.

In some embodiments, for example, based on the probe request transmitted by station 102, the AP 105 may transmit data packets to station 102 using STBC communication. Substantially entire packets transmitted by AP 105 to station 102 may be transmitted using STBC communication; for example, a preamble portion and/or a header portion of a data packet, and/or a data portion of the data packet, may be transmitted by AP 105 to station 102 using STBC communication, e.g., at substantially the lowest transmission rate (“basic rate”) of the wireless communication standard in use.

Similarly, for example, based on the probe request transmitted by station 103, the AP 105 may transmit data packets to station 103 using BF communication. Substantially entire packets transmitted by AP 105 to station 103 may be transmitted using BF communication; for example, a preamble portion and/or a header portion of a data packet, and/or a data portion of the data packet, may be transmitted by AP 105 to station 103 using BF communication, e.g., at substantially the lowest transmission rate (“basic rate”) of the wireless communication standard in use.

In some embodiments, optionally, the probe request transmitted by station 103 may be utilized by AP 105 as an initial implicit feedback, which may be required to initiate or configure a BF transmission by AP 105 to station 103. Optionally, subsequent acknowledgement packets transmitted by station 103 may further be utilized by AP 105 as implicit feedback for subsequent BF transmissions by AP 105 to station 103.

In some embodiments, a station may transmit more than once a probe request to AP 105, the probe request including a RTS field and a RTS parameter. For example, station 102 may transmit a first probe request to initiate STBC communications with AP 105, e.g., when station 102 is remote from AP 105. The STBC communications may be, for example, at substantially the lowest transmission rate (“basic rate”) of the wireless communication standard in use. Subsequently, station 102 may be in proximity to AP 105, or station 102 may reliably receive signals from AP 105, such that non-STBC communication may be utilized, e.g., at a higher transmission rate. Then, station 102 may again be remote from AP 105, or may not reliable receive signals from AP 105, such that STBC communication may be utilized again. Accordingly, probe requests may be transmitted by station 102 to request the AP 105 to switch among transmission schemes, e.g., STBC and non-STBC. Similarly, station 103 may utilize probe requests to request the AP 105 to switch among transmission schemes, e.g., BF and non-BF.

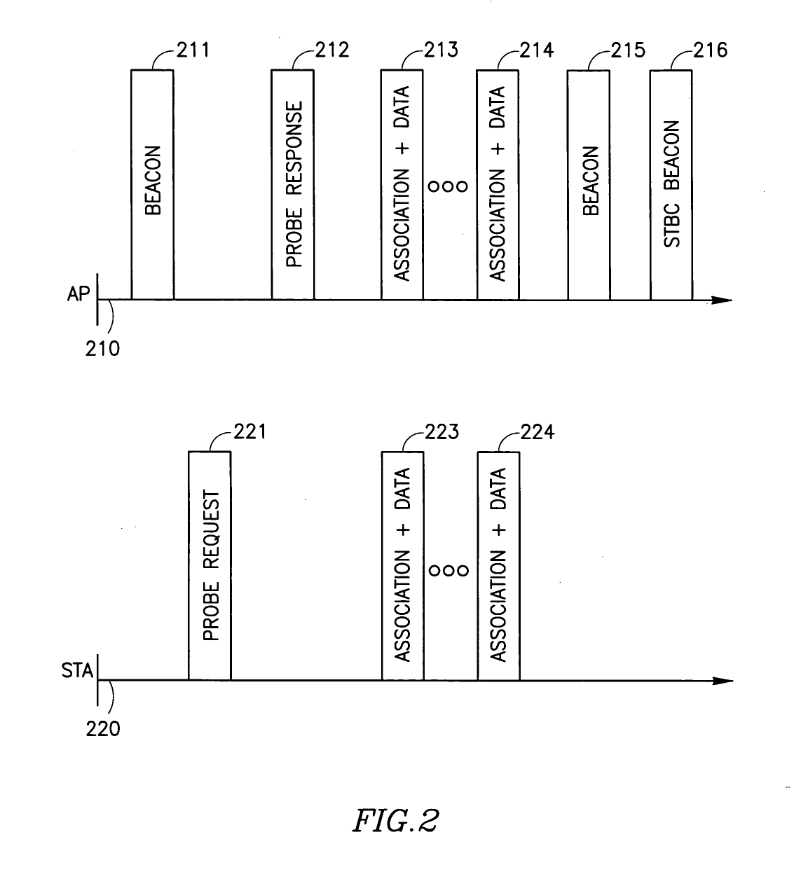

FIG. 2 schematically illustrates a timing diagram of wireless communication signals in accordance with an embodiment of the invention. A horizontal axis 210 may indicate, for example, timing of wireless communication signals transmitted by a wireless AP, e.g., by AP 105 of FIG. 1; whereas a horizontal axis 220 may indicate, for example, timing of wireless communication signals transmitted by a wireless communication station, e.g., by station 102 of FIG. 1.

As indicated at block 211, a beacon signal may be transmitted by the AP, for example, in accordance with a wireless communication standard, e.g., IEEE 802.11n standard. For example, the beacon may be transmitted using non-STBC and/or non-BF communication.

As indicated at block 221, a probe request may be transmitted by the station. For example, the probe request may include a parameter indicating a request that the AP transmit to the station using STBC communication.

As indicated at block 212, a probe response may be transmitted by the AP, e.g., using STBC communication.

As indicated at blocks 213-214 and 223-224, association and data transfer may be performed between the AP and the station, e.g., using STBC communication.

As indicated at blocks 215 and 216, optionally, a non-STBC beacon signal and a STBC beacon signal, respectively, may be transmitted by the AP, e.g., periodically.

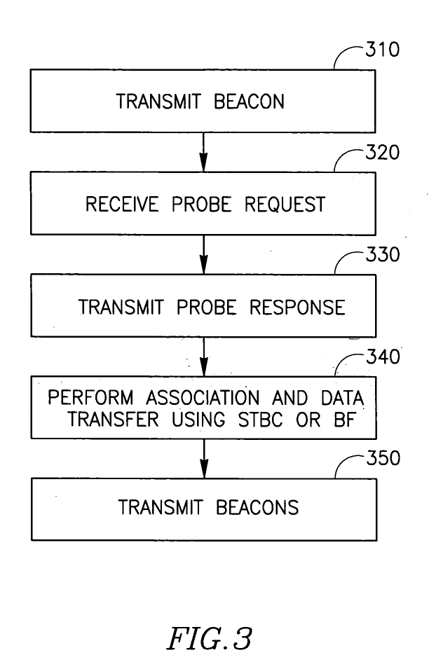

FIG. 3 is a schematic flow-chart of a method of extended-range wireless communication in accordance with an embodiment of the invention. Operations of the method may be implemented, for example, by system 100 of FIG. 1, by stations 102 and/or 103 of FIG. 1, by AP 105 of FIG. 1, and/or by other suitable stations, APs, transceivers, units, devices, and/or systems.

As indicated at box 310, the method may optionally include, for example, transmitting a beacon signal by the AP, for example, in accordance with a wireless communication standard, e.g., IEEE 802.11n standard. For example, the beacon may be transmitted using non-STBC and/or non-BF communication.

As indicated at box 320, the method may optionally include, for example, receiving by the AP a probe request transmitted by a station. For example, the probe request may include a value of a parameter (e.g., in a dedicated field of the probe request) indicating a request that the AP transmit to the station using TADS, for example, STBC or BF communication, or using other extended-range transmission scheme. The received probe request, and/or other information, may be used by the AP to determine that the AP is requested or required to transmit subsequent data packets using that extended-range transmission scheme (e.g., TADS, STBC, BF, or the like). Optionally, the probe request may include other requested attributes of the requested transmission mode, for example, a requested number of transmission antennas to be used, e.g., indicated using a value of a parameter or a value of a field included in the probe request.

As indicated at box 330, the method may optionally include, for example, transmitting a probe response by the AP, e.g., using the TADS (e.g., STBC or BF communication).

As indicated at box 340, the method may optionally include, for example, performing association and data transfer between the AP and the station, e.g., using TADS (e.g., STBC or BF communication). For example, the AP may transmit substantially all portions of a data packet, e.g., a preamble and/or header portion and a data portion, using TADS (e.g., STBC or BF communication).

As indicated at box 350, the method may optionally include, for example, transmitting by the AP a non-STBC beacon signal and a STBC beacon signal (or a TADS beacon signal), e.g., periodically or repeatedly.

Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by system 100 of FIG. 1, by AP 105 of FIG. 1, by processor 111 of FIG. 1, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 112), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
receiving a probe request indicating a requested transmission scheme; and
transmitting a data packet using the requested transmission scheme.

2. The method of claim 1, wherein receiving comprises:
receiving a probe request including a field having a value indicating said requested transmission scheme.

3. The method of claim 1, wherein receiving comprises:
receiving a probe request indicating a number of requested transmission antennas.

4. The method of claim 1, further comprising:
in response to said probe request, transmitting a probe response using said requested transmission scheme.

5. The method of claim 1, further comprising:
associating between a wireless access point and a wireless communication station using said requested transmission scheme.

6. The method of claim 1, further comprising:
in response to the probe request and if said requested transmission scheme is Space-Time Block Codes, periodically transmitting a beacon signal using Space-Time Block Codes.

7. The method of claim 1, comprising:
in response to said probe request, transmitting said data packet using the requested transmission scheme at substantially the lowest transmission rate of a wireless communication standard in use.

8. The method of claim 1, wherein transmitting comprises:
in response to the probe request and if said requested transmission scheme is Space-Time Block Codes, transmitting said data packet using protected Space-Time Block Codes to a wireless communication station that transmitted the probe request.

9. The method of claim 1, wherein transmitting comprises:
transmitting a header portion of said data packet and a data portion of said data packet using said requested transmission scheme.

10. The method of claim 1, wherein receiving comprises:
receiving a probe request including an indication that the requested transmission scheme is Space-Time Block Codes.

11. The method of claim 1, wherein receiving comprises:
receiving a probe request including an indication that the requested transmission scheme is a Beam Forming scheme.

12. An apparatus comprising:
a transmitter to transmit a data packet using a requested transmission scheme indicated in a probe request.

13. The apparatus of claim 12, wherein said probe request comprises a field having a value indicating said requested transmission scheme.

14. The apparatus of claim 12, wherein said probe request indicates a number of requested transmission antennas.

15. The apparatus of claim 12, wherein said transmitter is to transmit a header portion of said data packet and a data portion of said data packet using said requested transmission scheme.

16. The apparatus of claim 12, wherein said transmitter is to transmit, in response to said probe request and prior to transmitting said data packet, a probe response using said requested transmission scheme.

17. The apparatus of claim 12, wherein said transmitter is to associate between said apparatus and a wireless communication station using said requested transmission scheme.

18. The apparatus of claim 12, wherein said transmitter is to periodically transmit, in response to the probe request and if said requested transmission scheme is Space-Time Block Codes, a beacon signal using Space-Time Block Codes.

19. The apparatus of claim 12, wherein said transmitter is to transmit said data packet at substantially the lowest transmission rate of a wireless communication standard in use.

20. The apparatus of claim 12, wherein said transmitter is to transmit said data packet, in response to the probe request and if said requested transmission scheme is Space-Time Block Codes, using protected Space-Time Block Codes to a wireless communication station that transmitted the probe request.

21. The apparatus of claim 12, further comprising:
a receiver to receive said probe request transmitted by a wireless communication station having low reception reliability.

22. The apparatus of claim 12, wherein said probe request indicates that the requested transmission scheme is Space-Time Block Codes.

23. The apparatus of claim 12, wherein said probe request indicates that the requested transmission scheme is a Beam Forming scheme.

24. The apparatus of claim 12, wherein said apparatus comprises a wireless access point.

25. A wireless communication system comprising:
an access point comprising:
a dipole antenna to send wireless communication signals; and
a transmitter to transmit a data packet using a requested transmission scheme indicated in a probe request.

26. The wireless communication system of claim 25, wherein said probe request comprises a field having a value indicating said requested transmission scheme.

27. The wireless communication system of claim 25, wherein said probe request indicates a number of requested transmission antennas.
